(19) United States
(12) Patent Application Publication
(10) Pub. No.: US 2022/0367088 A1
(43) Pub. Date: Nov. 17, 2022

(54) BRANCHED WIRE HARNESS MANUFACTURING METHOD

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yuji KAWATA, Mie (JP); Kenji MIYAMOTO, Mie (JP)

(21) Appl. No.: 17/761,853

(22) PCT Filed: Aug. 28, 2020
(86) PCT No.: PCT/JP2020/032579

§ 371 Date: Mar. 18, 2022

(30) Foreign Application Priority Data
Sep. 24, 2019 (JP) 2019-172543

(51) Int. Cl. H01B 13/012; H01R 4/72

(52) U.S. Cl. CPC H01B 13/01281; H01R 4/72; H01B 13/01254

(57) ABSTRACT

A method for manufacturing a branched wire harness 1 includes a connection step of bundling and connecting core wires 11 of a plurality of electric wires 10 including the core wires 11; a waterproof material attachment step of attaching, to the plurality of electric wires 10, a spring-shaped waterproof material 20 constituted by a material that is softened or melted through heating; a covering step of covering, with a waterproof covering 14, the plurality of electric wires 10 to which the spring-shaped waterproof material 20 is attached; and a heating step of softening or melting the spring-shaped waterproof material 20 through heating, and filling in a gap between the waterproof covering 14 and the electric wires 10, or a gap between the adjacent electric wires 10.

### TECHNICAL FIELD

The technique disclosed by the present specification relates to a branched wire harness manufacturing method.

### BACKGROUND

A branched wire harness in which core wires of a plurality of electric wires are bundled and electrically connected is known. In this type of branched wire harness, a region where the core wire is exposed from the insulating covering of the electric wire is covered with a waterproof covering such as a heat-shrinkable tube to prevent the exposed region from being exposed to water. However, if there is a large number of electric wires, if electric wires with different outer diameters are connected to each other, or the like, there is concern that water will enter through a gap between the electric wires or a gap between the electric wires and the waterproof covering. In order to solve this problem, a method of sandwiching a waterproof block between adjacent electric wires (see Patent Document 1), a method of attaching a waterproof spacer having an insertion hole corresponding to each of a plurality of electric wires (see Patent Document 2), a method of using a waterproof covering including a branched tube portion corresponding to each of a plurality of electric wires (see Patent Document 3), and the like have been devised.

### PRIOR ART DOCUMENT

### Patent Document

Patent Document 1: JP 2002-252918 A
Patent Document 2: JP 2004-048832 A
Patent Document 3: JP 2010-130867 A

### SUMMARY OF THE INVENTION

### Problems to be Solved

With the method of sandwiching the waterproof block between adjacent electric wires, when the number of connected electric wires increases, the task of sandwiching the waterproof blocks one by one between the adjacent electric wires requires labor, thus complicating the manufacturing step. Also, the number of parts increases and the manufacturing cost increases. Also, in the method of attaching a waterproof spacer with an insertion hole and the method of using a waterproof covering having a branch tube portion, it is necessary to newly create a member when the number or size of the connected electric wires is changed, and thus the manufacturing step becomes complicated.

### Means to Solve the Problem

The branched wire harness manufacturing method disclosed herein includes: a connection step of bundling and connecting core wires of a plurality of electric wires including the core wires; a waterproof material attachment step of attaching, to the plurality of electric wires, a spring-shaped waterproof material obtained by winding, into a spiral shape, a wire material constituted by a material that is softened or melted by heating, such that the wire material enters between the adjacent electric wires; a covering step of covering, with a waterproof covering, the plurality of electric wires to which the spring-shaped waterproof material is attached; and a heating step of softening or melting the spring-shaped waterproof material through heating and filling in a gap between the waterproof covering and the electric wires, or a gap between the adjacent electric wire.

### Effect of the Invention

According to the branched wire harness manufacturing method disclosed in the present specification, it is possible to simplify the manufacturing step and reduce the number of parts.

### BRIEF DESCRIPTION OF THE DRAWINGS

FIG. 1 is a perspective view of a branched wire harness of an embodiment.

FIG. 2 is a cross-sectional view taken along the line A-A of FIG. 1.

FIG. 3 is a perspective view showing a step of bundling and connecting core wires of a plurality of electric wires in an embodiment.

FIG. 4 is a perspective view showing a step of attaching a spring-shaped waterproof material to an electric wire in an embodiment.

FIG. 5 is a cross-sectional view taken along line B-B of FIG. 4.

FIG. 6 is a cross-sectional view showing a step of covering, with a heat-shrinkable tube, an electric wire to which a spring-shaped waterproof material is attached, in an embodiment.

FIG. 7 is a side view showing a step of making a cut in a base cylinder, which is a base material of a spring-shaped waterproof material in an embodiment.

FIG. 8 is a side view showing a step of removing an unnecessary portion from a base cylinder to form a spring-shaped waterproof material in an embodiment.

FIG. 9 is a perspective view showing a step of attaching a spring-shaped waterproof material to an electric wire in a first modified example.

FIG. 10 is a side view showing a step of forming a spring-shaped waterproof material in a second modified example.

### DETAILED DESCRIPTION TO EXECUTE THE INVENTION

### Summary of Embodiments

The branched wire harness manufacturing method disclosed in the present specification includes: a connection step of bundling and connecting core wires of a plurality of electric wires including the core wires; a waterproof material attachment step of attaching, to the plurality of electric wires, a spring-shaped waterproof material obtained by winding, into a spiral shape, a wire material constituted by a material that is softened or melted by heating, such that the wire material enters between the adjacent electric wires; a covering step of covering, with a waterproof covering, the plurality of electric wires to which the spring-shaped waterproof material is attached; and a heating step of softening or melting the spring-shaped waterproof material through heating and filling in a gap between the waterproof covering and the electric wires, or a gap between the adjacent electric wires.

According to the above configuration, the spring-shaped waterproof material attached to the electric wire is softened or melted by heating and flows to fill the gap between the waterproof covering and the electric wires, or the gap between the adjacent electric wires. This prevents water from entering through the gap between the waterproof covering and the electric wires and the gap between the adjacent electric wires. Here, the work of attaching the spring-shaped waterproof material to the electric wires requires less labor than the conventional method of sandwiching the waterproof block between the adjacent electric wires. Also, the spring-shaped waterproof material can be attached by being cut to the required length according to the number, outer diameter, and the like of the electric wires included in the branched wire harness, or by being expanded and contracted according to the size of the electric wire. For this reason, even if the number or size of the electric wires included in the branched wire harness is changed, it is not necessary to newly create a member. In this manner, according to the above-described manufacturing method, it is possible to simplify the manufacturing step and reduce the number of parts.

In the above-described configuration, an adhesive layer may be disposed on an inner circumferential surface of the waterproof covering, and the adhesive layer may be constituted by a material of the same type as the spring-shaped waterproof material.

According to such a configuration, the adhesive layer and the spring-shaped waterproof material are softened or melted by heating to flow, and are integrated to fill in a gap between the waterproof covering and the electric wire or a gap between adjacent electric wires. As a result, water is reliably prevented from entering through the gap between the waterproof covering and the electric wires and the gap between the adjacent electric wires.

In the above-described configuration, the waterproof covering may be constituted by a material configured to shrink due to being heated.

According to such a configuration, the inner diameter of the waterproof covering can be increased to such a degree that the task of inserting a plurality of electric wires into the interior can be easily performed in the covering step. Then, in the heating step, the waterproof covering is shrunk, whereby the gap between the waterproof covering and the electric wires, that is, the space to be filled by the spring-shaped waterproof material, can be reduced. As a result, water is reliably prevented from entering through the gap between the electric wires and the waterproof covering.

Details of Embodiments Specific examples of the technique disclosed by the present specification will be described below with reference to the drawings. It should be noted that the present invention is not limited to these examples, and is indicated by the scope of claims, and all modifications within the meaning and scope equivalent to the scope of claims are intended to be encompassed therein.

### Embodiment

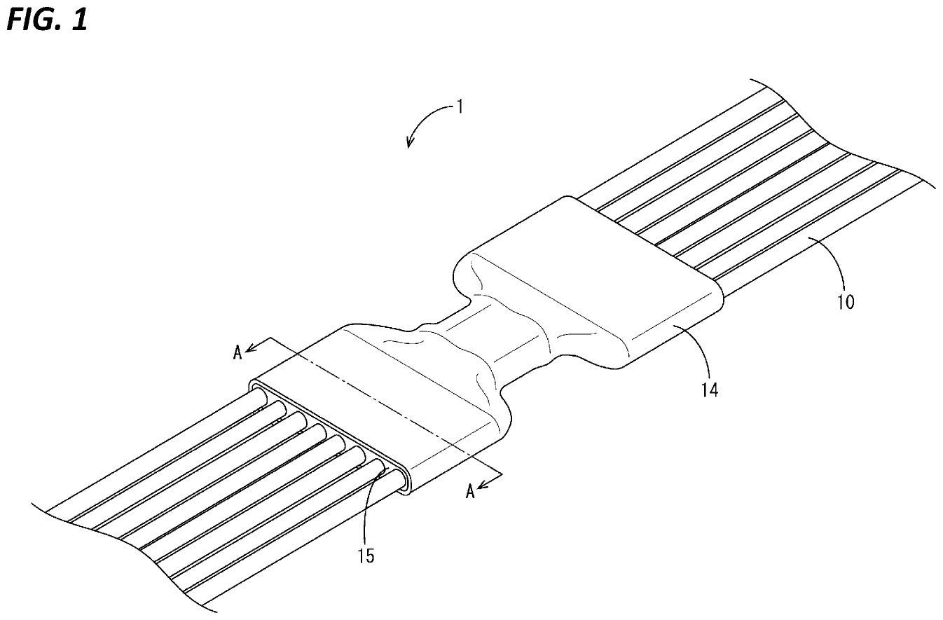

An embodiment will be described with reference to FIGS. 1 to 8. As shown in FIG. 1, the branched wire harness 1 of the present embodiment includes a plurality of electric wires 10 connected to each other, a waterproof covering 14, and a waterproof material 15.

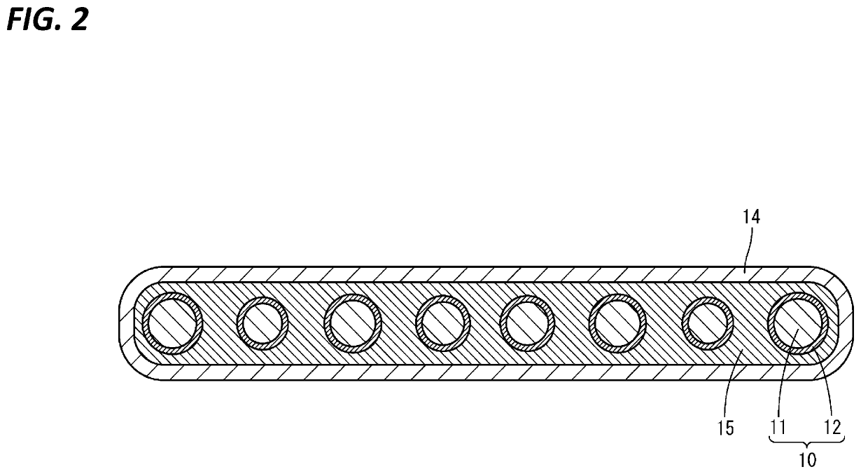

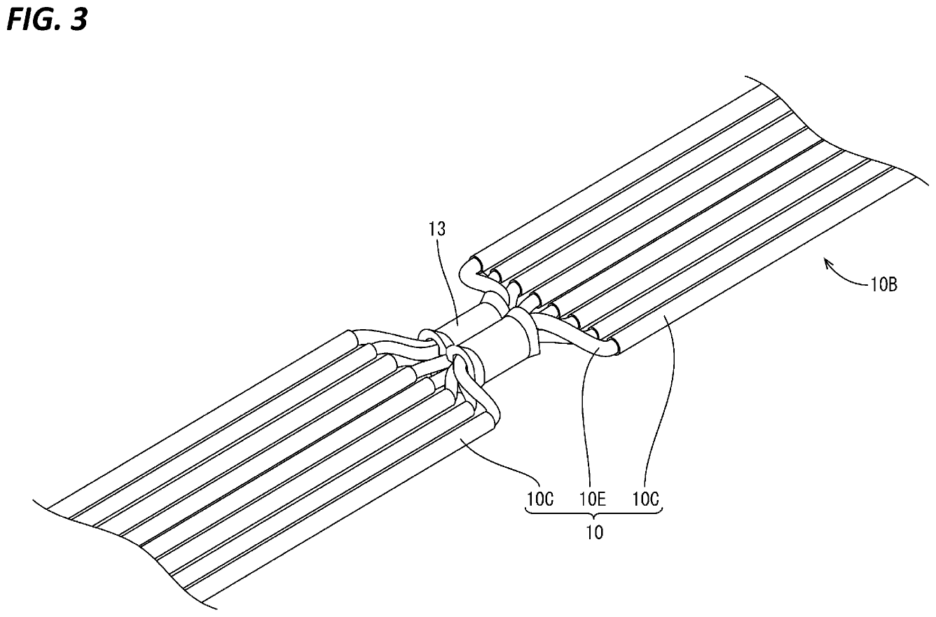

As shown in FIG. 2, each of the plurality of electric wires 10 includes a core wire 11 constituted by a stranded wire obtained by twisting together a plurality of metal strands, and an insulating covering 12 made of synthetic resin that covers the core wire 11. As shown in FIG. 3, each electric wire 10 has a covered portion 10C at which the core wire 11 is covered with the insulating covering 12, and an exposed portion 10E at which the insulating covering 12 is stripped off and the core wire 11 is exposed. The exposed portion 10E is arranged at an intermediate portion between both ends of the electric wire 10.

As shown in FIG. 3, the plurality of electric wires 10 are electrically connected due to the core wires 11 exposed at the exposed portions 10E being bundled and a crimp terminal 13 being crimped to the bundled portion. The crimp terminal 13 is made of metal and is crimped so as to be wrapped around the bundled core wires 11.

As shown in FIGS. 1 and 2, the waterproof covering 14 is tube-shaped and is made of a material that is waterproof and shrinks when heated. In the present embodiment, the waterproof covering 14 collectively covers the exposed portions 10E crimped by the crimp terminal 13 and the covered portions 10C adjacent to the exposed portions 10E in the plurality of electric wires 10. One end of the waterproof covering 14 covers the covered portions 10C adjacent to one end of the exposed portions 10E, and the other end of the waterproof covering 14 covers the covered portions 10C adjacent to the other end of the exposed portions 10E. Examples of the material constituting the waterproof covering 14 include synthetic resin materials such as crosslinked polyolefin resin.

As shown in FIG. 2, the waterproof material 15 is arranged inside the waterproof covering 14 so as to fill the gap between the waterproof covering 14 and the electric wires 10 and the gaps between the electric wires 10. The waterproof material 15 is made of a material that has no fluidity at room temperature, but softens or melts and flows when heated. Examples of the material constituting the waterproof material 15 include a hot melt adhesive.

Next, an example of a method for manufacturing the branched wire harness 1 configured as described above will be described.

First, the core wires 11 exposed at the exposed portions 10E of the plurality of electric wires 10 are bundled, and the bundled portion is crimped by the crimp terminal 13 (connection step; see FIG. 3). As a result, a wire bundle 10B in which a plurality of electric wires 10 are connected to each other is obtained.

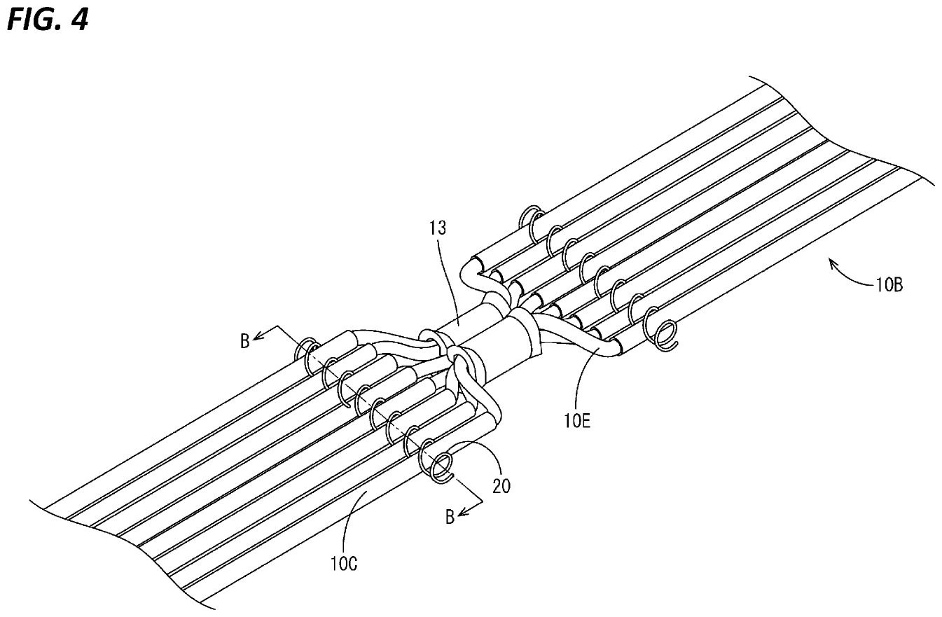

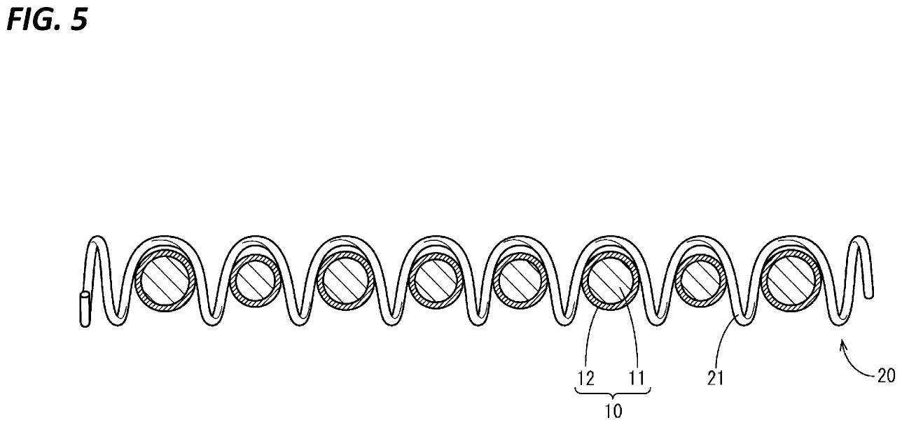

Next, spring-shaped waterproof materials 20 are attached to the wire bundle 10B (waterproof material attachment step; see FIG. 4). As shown in FIGS. 4 and 5, the spring-shaped waterproof materials 20 are coil spring-shaped members obtained by winding wire materials 21 in a spiral shape. The wire material 21 is constituted by a material that has no fluidity at room temperature, but softens or melts and flows when heated. In the present embodiment, the wire material 21 is constituted by a hot melt adhesive. As shown in FIG. 4, the covered portions 10C of the plurality of electric wires 10 adjacent to one end of the exposed portions 10E (the lower left end of FIG. 4) are aligned in a row, and one spring-shaped waterproof material 20 is attached to this portion. As shown in FIG. 5, the spring-shaped waterproof material 20 is attached such that the wire material 21 enters the gaps between the adjacent electric wires 10. Also, the covered portions 10C of the plurality of electric wires 10 adjacent to the other end of the exposed portions 10E (upper right end in FIG. 4) are aligned in a row in the same manner, and one other spring-shaped waterproof material 20 is attached to this portion.

The task of attaching the spring-shaped waterproof materials 20 to the electric wires 10 in this manner requires less labor than the conventional method of sandwiching a waterproof block between adjacent electric wires. Also, the spring-shaped waterproof materials 20 can be attached by being cut or expanded/contracted to a required length according to the number, the outer diameter, and the like of the electric wires 10. For this reason, if the number or size of the electric wires 10 provided in the branched wire harness 1 is changed, it is not necessary to newly create a member. Also, even if a plurality of electric wires 10 having different outer diameters are combined, the spring-shaped waterproof material 20 can be attached by being partially expanded and contracted according to the outer diameter of each electric wire 10.

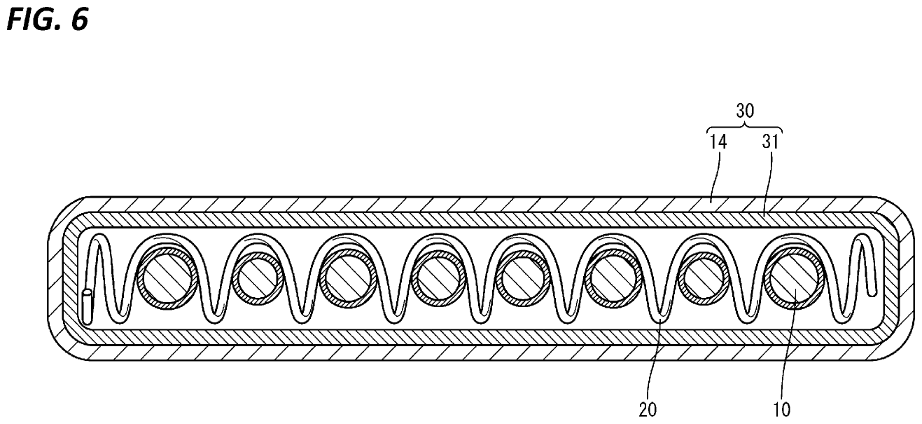

Next, the wire bundle 10B to which the spring-shaped waterproof material 20 is attached is inserted into the interior of the heat-shrinkable tube 30 (covering step: see FIG. 6). In the plurality of electric wires 10, the exposed portions 10E crimped by the crimp terminal 13 and the covered portions 10C that are adjacent to one end and the other end of the exposed portions 10E and to which the spring-shaped waterproof material 20 is attached are covered by the heat-shrinkable tube 30. As shown in FIG. 6, the heat-shrinkable tube 30 includes a tubular waterproof covering 14 and an adhesive layer 31 arranged over the entire inner peripheral surface of the waterproof covering 14. The waterproof covering 14 is made of a synthetic resin material that is waterproof and shrinks when heated. The adhesive layer 31 is made of a material that has no fluidity at room temperature, but softens or melts and flows when heated. In the present embodiment, the adhesive layer 31 is made of a hot melt adhesive of the same type as the material constituting the spring-shaped waterproof material 20. Since the heat-shrinkable tube 30 has an inner diameter one size larger than that of the electric wire bundle 10B inserted into the interior before the waterproof covering 14 is heat-shrunk, the electric wire bundle 10B is easily inserted through the interior of the heat-shrinkable tube 30.

Next, the heat-shrinkable tube 30 is heat-treated with the electric wire bundle 10B inserted inside (heating step). The heating temperature is a temperature at which the waterproof covering 14 shrinks and the adhesive layer 31 and the spring-shaped waterproof material 20 soften or melt. The heating causes the waterproof covering 14 to shrink (see FIG. 1). Also, the adhesive layer 31 and the spring-shaped waterproof material 20 are softened and melted to flow and are integrated to become the waterproof material 15, and fill the gap between the waterproof covering 14 and the electric wires 10, and the gaps between the adjacent electric wires 10 (see FIG. 2). As a result, water is prevented from entering through the gap between the waterproof covering 14 and the electric wires 10 and the gaps between the adjacent electric wires 10. The branched wire harness 1 is completed as described above.

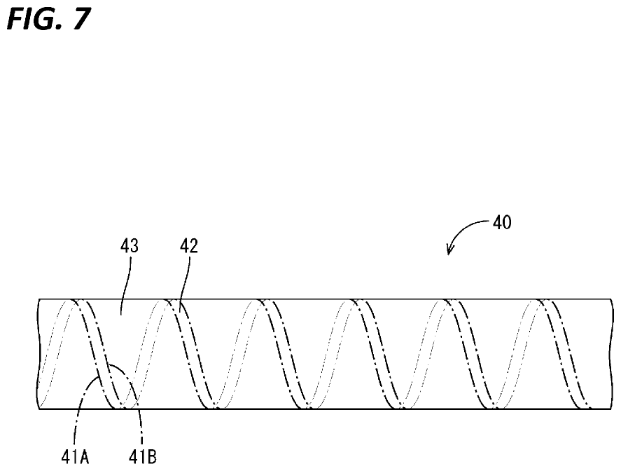

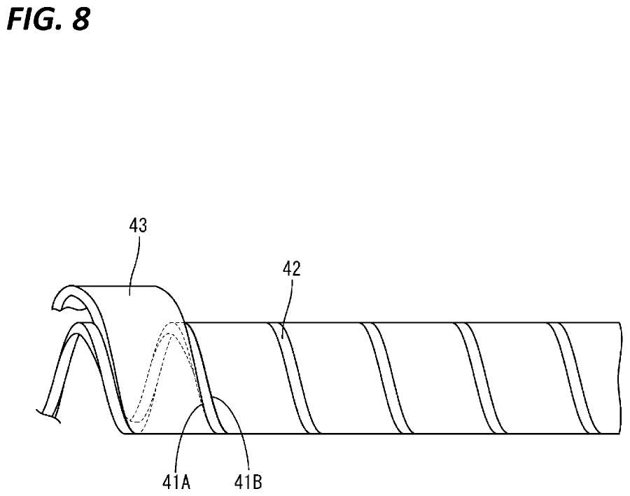

Hereinafter, an example of a method for manufacturing the spring-shaped waterproof material 20 as described above will be described. As shown in FIG. 7, the material of the spring-shaped waterproof material 20 is a tubular base cylinder 40 made of a hot melt adhesive. First, two spiral cuts 41A and 41B parallel to each other are inserted into the base cylinder 40. Next, as shown in FIG. 8, a spiral portion 42 formed linearly between the two cuts 41A and 41B is left, and a remaining unnecessary portion 43 is removed. The remaining spiral portion 42 becomes the spiral-shaped waterproof material 15. The inner diameter and outer diameter of the base cylinder 40, the distance between the two cuts 41A and 41B, and the like can be set as appropriate according to the inner diameter, outer diameter, wire diameter, pitch, and the like of the spring-shaped waterproof material 20 to be obtained.

As described above, according to the present embodiment, the method for manufacturing the branched wire harness 1 includes: a connection step of bundling and connecting core wires 11 of a plurality of electric wires 10 including the core wires 11; a waterproof material attachment step of attaching, to the plurality of electric wires 10, a spring-shaped waterproof material 20 obtained by winding, into a spiral shape, a wire material 21 constituted by a material that is softened or melted by heating, such that the wire material 21 enters between the adjacent electric wires 10; a covering step of covering, with a waterproof covering 4, the plurality of electric wires 10 to which the spring-shaped waterproof material 20 is attached; and a heating step of softening or melting the spring-shaped waterproof material 20 through heating and filling in a gap between the waterproof covering and the electric wires 10, or a gap between the adjacent electric wires 10.

According to the above-described configuration, the spring-shaped waterproof material 20 attached to the electric wires 10 is softened or melted by heating and flows to fill a gap between the waterproof covering 14 and the electric wires 10 or gaps between adjacent electric wires 10. As a result, water is prevented from entering through the gap between the waterproof covering 14 and the electric wires 10 and the gaps between the adjacent electric wires 10. Here, the task of attaching the spring-shaped waterproof material 20 to the electric wire 10 requires less labor than the conventional method using a waterproof block. Also, the spring-shaped waterproof material 20 can be attached by being cut or expanded/contracted to a required length according to the number, outer diameter, and the like of the electric wires 10 provided in the branched wire harness 1. For this reason, even if the number or size of the electric wires 10 included in the branched wire harness 1 is changed, it is not necessary to newly create a member. In this manner, according to the above-described manufacturing method, it is possible to simplify the manufacturing step and reduce the number of parts.

Also, an adhesive layer 31 is arranged on the inner peripheral surface of the waterproof covering 14, and the adhesive layer 31 is made of the same material as the spring-shaped waterproof material 20. According to such a configuration, the adhesive layer 31 and the spring-shaped waterproof material 20 are softened or melted by heating, and flow and are integrated to fill in the gap between the waterproof covering 14 and the electric wires 10 or the gaps between the adjacent electric wires 10. As a result, water is reliably prevented from entering through the gap between the waterproof covering 14 and the electric wires 10 and the gaps between the adjacent electric wires 10.

Also, the waterproof covering 14 is made of a material that shrinks when heated. According to such a configuration, in the heating step, the waterproof covering 14 is shrunk, whereby the gap between the waterproof covering 14 and the electric wires 10, that is, the space to be filled by the spring-shaped waterproof material 20, can be reduced. As a result, water is reliably prevented from entering through the gap between the electric wires 10 and the waterproof covering 14.

### First Modified Example

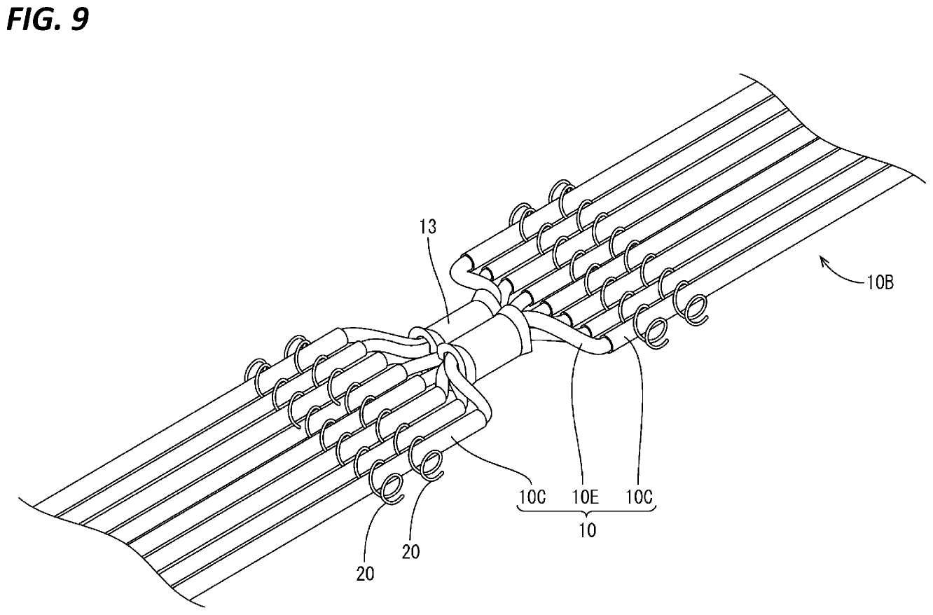

In the waterproof material attachment step, as shown in FIG. 9, two or more spring-shaped waterproof materials 20 may be attached to the covered portions 10C of the plurality of electric wires 10 adjacent to one end of the exposed portions 10E (the lower left end of FIG. 9). Similarly, two or more spring-shaped waterproof materials 20 may be attached to the covered portions 10C of the plurality of electric wires 10 adjacent to the other end of the exposed portions 10E (upper right end in FIG. 9).

### Second Modified Example

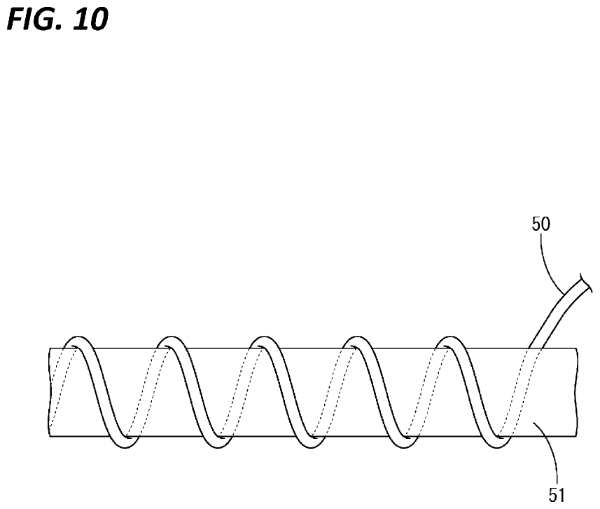

Hereinafter, another example of a method for manufacturing the spring-shaped waterproof material 20 will be described. First, as shown in FIG. 10, a linear waterproof strand 50 made of a material that is softened by heating is wrapped in a spiral shape around a round bar-shaped iron core 51. Next, the waterproof strand 50 wrapped around the iron core 51 is heated. Next, the heated waterproof strand 50 is rapidly cooled, whereby the shape of the waterproof strand 50 is fixed in a spiral shape. After cooling, the iron core 51 is pulled out to obtain the spring-shaped waterproof material 20. The outer diameter and wrapping pitch of the waterproof strand 50, the outer diameter of the iron core 51, and the like can be set as appropriate according to the inner diameter, outer diameter, wire diameter, pitch, and the like of the spring-shaped waterproof material 20 to be obtained.

### Other Embodiments

(1) In the above-described embodiment, in the plurality of electric wires 10, the exposed portions 10E at which the core wires 11 are exposed from the insulating coverings was located at an intermediate portion between both ends, but the exposed portions may also be located at the terminal ends of the electric wire. Also, an electric wire in which the exposed portion 10E is located at an intermediate portion and an electric wire in which the exposed portion 10E is located at the terminal end may be used in combination with each other.

(2) In the above-described embodiment, the adhesive layer 31 of the heat-shrinkable tube 30 was made of the same material as the material constituting the spring-shaped waterproof material 20, but the adhesive layer may also be constituted by a material different from that of the spring-shaped waterproof material.

(3) In the above-described embodiment, the heat-shrinkable tube 30 included the adhesive layer 31, but the heat-shrinkable tube need not include the adhesive layer.

(4) In the above-described embodiment, the covered portions 10C of the plurality of electric wires 10 adjacent to the exposed portions 10E were aligned in one row, but the covered portions may also be aligned in two rows or three or more rows.

(5) In the above-described embodiment, the waterproof covering 14 was made of a material that shrinks when heated, but the waterproof covering may also be made of a material that does not shrink when heated.

(6) In the above-described embodiment, the heat-shrinkable tube 30 had a tubular shape, but the method of covering the electric wire in the covering step is not limited to the above embodiment, and for example, a tape-shaped waterproof covering may also be wrapped around the electric wires.

(7) In the above-described embodiment, a plurality of core wires 11 were connected by the crimp terminal 13, but the method for connecting the core wires is not limited to the above embodiment, and for example, the plurality of core wires 11 may also be connected using ultrasonic welding or resistance welding.

### LIST OF REFERENCE NUMERALS

10 Electric wire
10B Electric wire bundle
10C Covered portion
10E Exposed portion
11 Core wire
12 Insulating covering
13 Crimp terminal
14 Waterproof covering
15 Waterproof material
20 Spring-shaped waterproof material
21 Wire material
30 Heat-shrinkable tube
31 Adhesive layer
40 Base cylinder
41A, 41B Cut
42 Spiral portion
43 Remaining unnecessary portion
50 Waterproof strand
51 Iron core

1. A branched wire harness manufacturing method, comprising:
a connection step of bundling and connecting core wires of a plurality of electric wires including the core wires;
a waterproof material attachment step of attaching, to the plurality of electric wires, a spring-shaped waterproof material obtained by winding, into a spiral shape, a wire material constituted by a material that is softened or melted by heating, such that the wire material enters between the adjacent electric wires;
a covering step of covering, with a waterproof covering, the plurality of electric wires to which the spring-shaped waterproof material is attached; and
a heating step of softening or melting the spring-shaped waterproof material through heating and filling in a gap between the waterproof covering and the electric wires, or a gap between the adjacent electric wires.

2. The branched wire harness manufacturing method according to claim 1,
wherein an adhesive layer is disposed on an inner circumferential surface of the waterproof covering, and
the adhesive layer is constituted by a material of the same type as the spring-shaped waterproof material.

3. The branched wire harness manufacturing method according to claim 1,
wherein the waterproof covering is constituted by a material configured to shrink due to being heated.
